(19) United States
(12) Patent Application Publication
(10) Pub. No.: US 2011/0254820 A1
(43) Pub. Date: Oct. 20, 2011

(54) ELECTROPHORETIC DISPLAY DEVICE AND METHOD FOR DRIVING THE SAME

(75) Inventors: Chi-ming Lu, Puxin Township (TW); Hung-hsiang Chen, Zhongli City (TW); Yi-nan Chu, Tianwei Township (TW)

(73) Assignee: CHUNGHWA PICTURE TUBES, LTD., Bade City (TW)

(21) Appl. No.: 12/815,384

(22) Filed: Jun. 14, 2010

(30) Foreign Application Priority Data
Apr. 19, 2010 (TW) 099112193

(51) Int. Cl. G09G 5/00

(52) U.S. Cl. 345/211; 345/107

(57) ABSTRACT

An electrophoretic display device and a method for driving the same are disclosed. The electrophoretic display device includes a plurality of pixels, a first electrode layer, a second electrode layer, a driving voltage generating unit, and an electrophoretic layer disposed between the first electrode layer and the second electrode layer. The driving voltage generating unit is capable of providing a plurality of various driving voltages to drive charged particles in the electrophoretic layer, so as to increase the number of gray levels displayed by the electrophoretic display device.

### TECHNICAL FIELD OF THE INVENTION

The present invention relates to an electrophoretic display device, and more particularly to an electrophoretic display device and a method for driving the same.

### BACKGROUND OF THE INVENTION

Please refer to FIG. 1, which illustrates a conventional electrophoretic display device display principle. An electrophoretic layer 50 is sealed between two films 120 for displaying images. The electrophoretic layer 50 comprises a plurality of charged particles 100 and a solution 110 for suspending the charged particles 100. In the electrophoretic layer 50, the charged particles 100 are driven by an electric field formed between the first electrode 130 and the second electrode 140, so as to change locations of the charged particles 100 for displaying different gray levels.

Please refer to FIG. 2 and FIG. 3. FIG. 2 illustrates a graph showing a relationship between the driving time and the gray level in the conventional electrophoretic display device. FIG. 3 illustrates the locations of the charged particles 100 versus the corresponding gray levels. As shown in FIG. 2, when the driving time of the electrophoretic display device is short, the gray level is low. When the driving time of the electrophoretic display device is long, the gray level is high. Further, as shown in FIG. 3, when the charged particles 100 are white, if they are further away from the top surface of the electrophoretic display device (i.e. at a lower location in FIG. 3), the gray level of the electrophoretic display device will be low; if the charged particles 100 are closer to the top surface of the electrophoretic display device (i.e. at an upper location in FIG. 3), the gray level of the electrophoretic display device will be high. By changing the locations of the charged particles 100 to reflect light received from the environment, the electrophoretic display device is capable of showing the color contrast of the charged particles 100 for displaying images. The aforesaid display principle is known as a total reflective display technology. Thus, the electrophoretic display device does not require a backlight module.

Currently, the driving voltages are provided by a source driving circuit (not shown), and the source driving circuit can only output +/−15V to drive the charged particles 100 to change the locations thereof. However, a frame rate of the electrophoretic display device limits the number of gray levels which the electrophoretic display device can display. For instance, an output voltage being outputted by the source driving circuit lasts for 20 milliseconds (ms) at a frame rate of 50 Hz (Hertz). That is, one frame time is 20 ms. When the charged particles 100 are driven by a fixed voltage of +15V (or −15V), the gray level response time from the black level to the white level or from the white level to the black level is assumed to be 320 ms. Therefore, updating a complete image requires 16 multiples of a frame time (320 ms/20 ms=16). In an ideal situation, one gray level can be increased to the next one gray level in a frame time, for example, from the gray level 0 to the gray level 1. As a result, only 16 gray levels (from gray level 0 to gray level 15) can be displayed at the frame rate of 50 Hz, and the electrophoretic display device fails to display more gray levels so that the display image quality fails to be increased.

Therefore, there is a need for a solution to the above-mentioned problem that the electrophoretic display device fails to display more gray levels.

### SUMMARY OF THE INVENTION

A primary objective of the present invention is to provide an electrophoretic display device and a method for driving the same, which are capable of increasing the number of gray levels being displayed by the electrophoretic display device.

The electrophoretic display device according to the present invention comprises a plurality of pixels, a first electrode layer, a second electrode layer, a driving voltage generating unit, and an electrophoretic layer. The first electrode layer corresponds to the pixels. The second electrode layer corresponds to the first electrode layer and is coupled to a common voltage. The driving voltage generating unit is coupled to the first electrode layer for providing a set of driving voltages. The set of driving voltages comprises a maximum value, a minimum value, and at least one intermediate value. The electrophoretic layer is disposed between the first electrode layer and the second electrode layer. The electrophoretic layer comprises a plurality of charged particles. Each of the pixels corresponds to a proportion of the charged particles. The proportion of the charged particles is driven by an electric field which is formed by one of the set of the driving voltages and the common voltage.

In the method for driving the electrophoretic display device according to the present invention, the electrophoretic display device comprises a plurality of pixels, a first electrode layer, a second electrode layer corresponding to the first electrode layer, a driving voltage generating unit coupled to the first electrode layer, and an electrophoretic layer disposed between the first electrode layer and the second electrode layer. The electrophoretic layer comprises a plurality of charged particles. The first electrode layer corresponds to a plurality of pixels. Each of the pixels corresponds to a proportion of the charged particles. The method for driving the electrophoretic device according to the present invention comprises the steps of: providing at least one driving voltage corresponding to each of the pixels by the driving voltage generating unit; and providing a common voltage for the second electrode layer, and driving the proportion of the charged particles by an electric field formed by the at least one driving voltage corresponding to each of the pixels and the common voltage. The at least one driving voltage is one selected from a group consisting of a maximum value, a minimum value, and at least one intermediate value. The driving voltages corresponding to each of the pixels are respectively driven in different periods.

The electrophoretic display device and the method for driving the same according to the present invention provide a plurality of driving voltages to increase various locations of the charged particles. As a result, an object of increasing the number of gray levels being displayed by the electrophoretic display device can be achieved.

### BRIEF DESCRIPTION OF THE DRAWINGS

FIG. 1 illustrates a conventional electrophoretic display device display principle;

FIG. 2 illustrates a graph showing a relationship between the driving time and the gray level in the conventional electrophoretic display device;

FIG. 3 illustrates the locations of the charged particles versus the corresponding gray levels;

FIG. 4 which illustrates a system architecture of a method for driving an electrophoretic display device according to an embodiment of the present invention;

FIG. 5 illustrates a timing chart showing the source data signal S_{SD} which the controller inputs to the source driving circuit;

FIG. 6 illustrates the source data signal S_{SD} corresponding to the pixels of the electrophoretic display panel;

FIG. 7(a) illustrates a graph showing a relationship between the gray level and the driving time in the conventional electrophoretic display device; and

FIG. 7(b) illustrates a graph showing a relationship between the gray level and the driving time in the electrophoretic display device of the present invention.

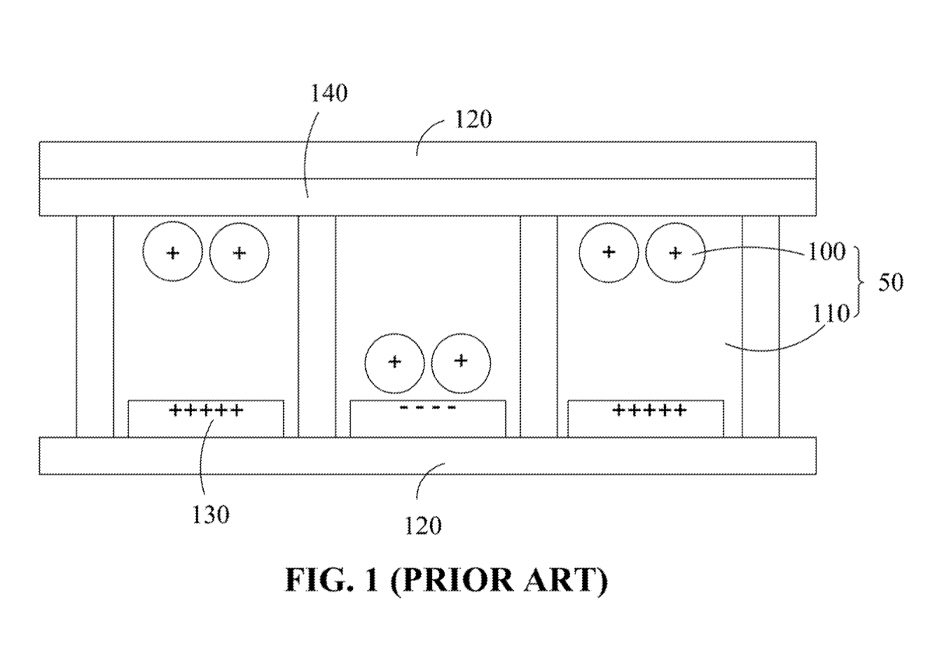

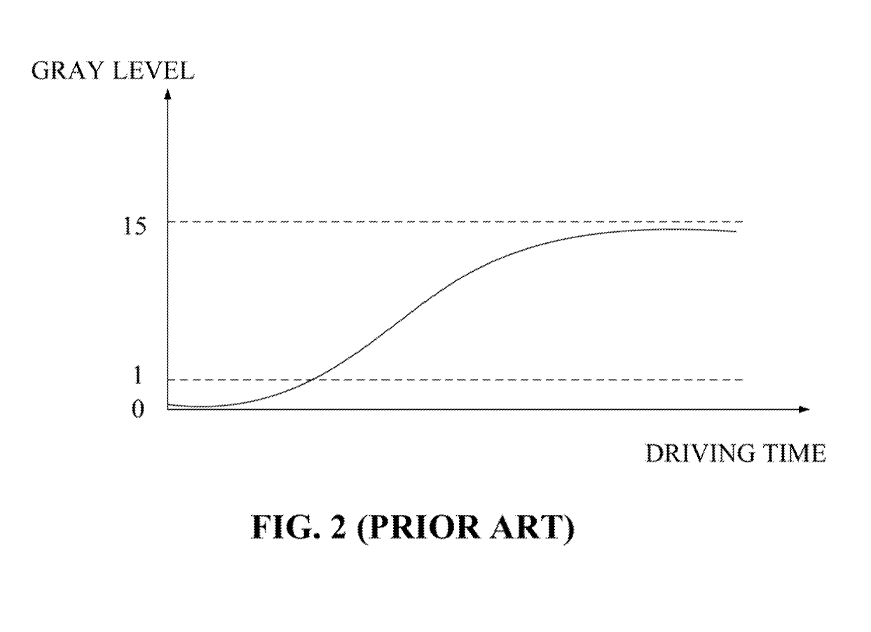

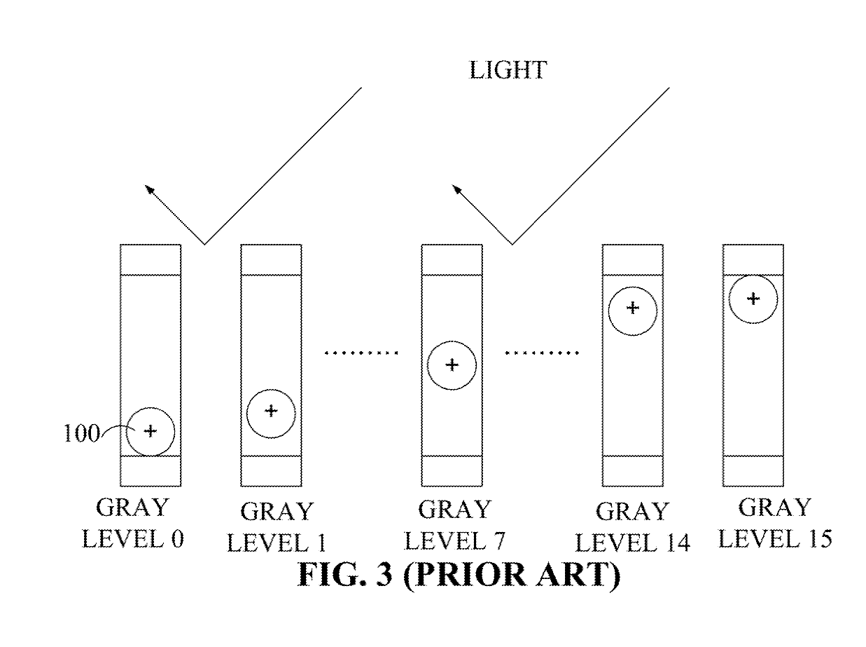

### DETAILED DESCRIPTION OF THE INVENTION

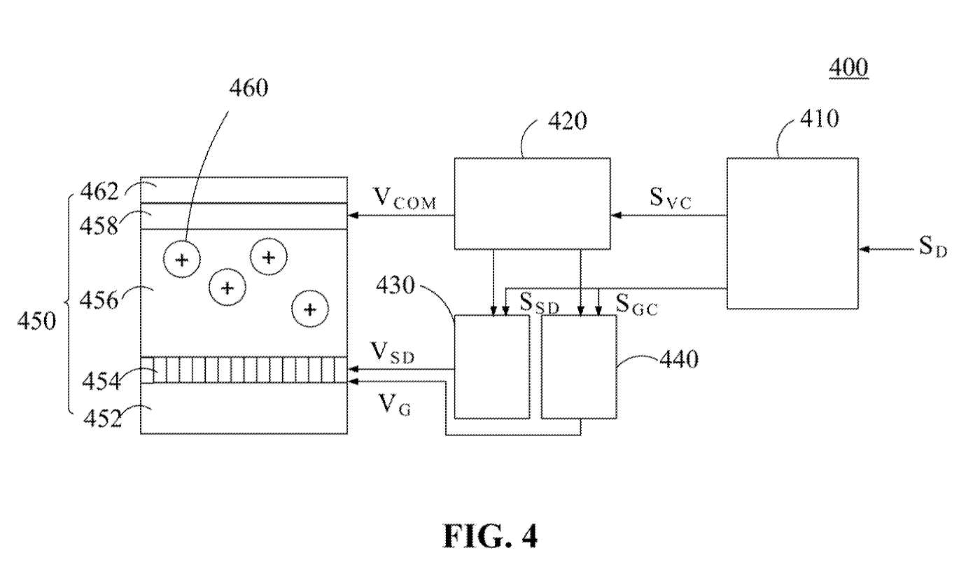

Please refer to FIG. 4, which illustrates a system architecture of a method for driving an electrophoretic display device 400 according to an embodiment of the present invention. The electrophoretic display device 400 comprises a controller 410, a power supply unit 420, a source driving circuit 430, a gate driving circuit 440, and an electrophoretic display panel 450. The electrophoretic display panel 450 comprises a first glass substrate 452, a first electrode layer 454, an electrophoretic layer 456, a second electrode layer 458, and a second glass substrate 462. In the present embodiment, the first electrode layer 454 is an indium tin oxide (ITO) layer being manufactured onto the first glass substrate 452. The second electrode layer 458 is an ITO layer being manufactured onto the second glass substrate 462. The second electrode layer 458 may be regarded as a common electrode layer corresponding to the first electrode layer 454. An electric field drives a plurality of charged particles 460 in the electrophoretic layer 456 to move to different locations for generating different gray levels. The electric field is formed between the first electrode layer 454 and the second electrode layer 458. The charged particles 460 may be positively charged particles or negatively charged particles.

A display data S_{D} is first inputted to the controller 410 when an image is required to be displayed. The display data S_{D} represents one complete image being displayed on the electrophoretic display panel 450. The controller 410 outputs a voltage controlling signal S_{VC} to the power supply unit 420 so as to control an output voltage from the power supply unit 420 according to the display data S_{D}. The power supply unit 420 further provides a common voltage V_{COM} for the second electrode layer 458. The controller 410 further outputs a gate controlling signal S_{GC} to the gate driving circuit 440, as well as outputs a source data signal S_{SD} to the source driving circuit 430. The gate driving circuit 440 selects a required voltage from the power supply unit 420 according to the gate controlling signal S_{GC}. The source driving circuit 430 selects a required voltage from the power supply unit 420 according to the source data signal S_{SD}.

The gate driving circuit 440 and the source driving circuit 430 respectively transform the required voltages selected from the power supply unit 420 into a gate voltage V_{G} and a source driving voltage V_{SD}. The gate voltage V_{G} and the source driving voltage V_{SD} are outputted to TFTs (thin film transistors; not shown) of corresponding pixels (not shown) on the first glass substrate 452. The gate voltage V_{G} is utilized to turn on and off the TFTs. The charged particles 460 in the electrophoretic layer 456 are driven to different locations for generating different gray levels by the electric field being formed by the source driving voltage V_{SD} and the common voltage V_{COM}.

In the prior art, the source driving voltage V_{SD} being outputted by the source driving circuit 430 comprises only two voltage levels, +/−15V. As a result, the number of the gray levels which can be displayed is limited at a fixed frame rate. According to the present invention, the source driving voltage V_{SD} is one selected from a group of voltage values consisting of a maximum value, a minimum value, and at least one intermediate value. By adding the at least one intermediate value, the charged particles 460 can be moved to various different locations so as to increase the number of the gray levels that can be displayed by the electrophoretic display panel 450.

It is noted that the source driving circuit 430 in the embodiment of FIG. 4 serves as a driving voltage generating unit. In another embodiment, as long as a device is capable of providing a plurality of driving voltages, such as a power supply, the device may serve as the driving voltage generating unit.

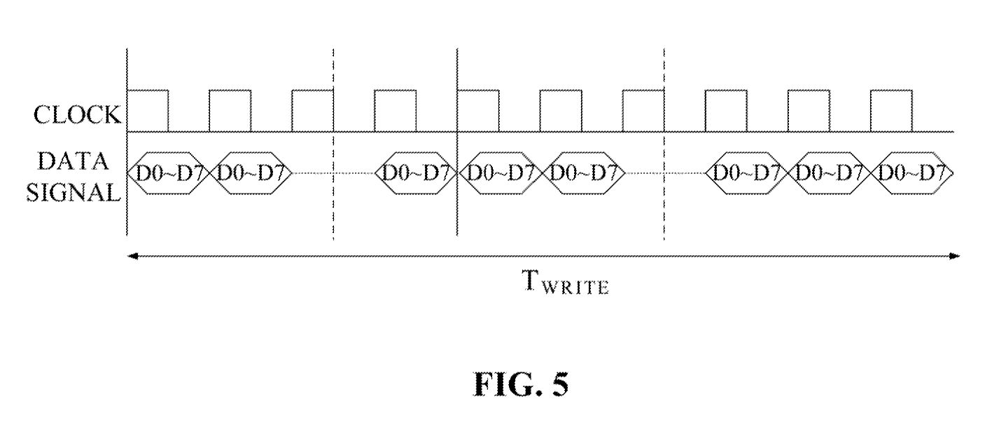

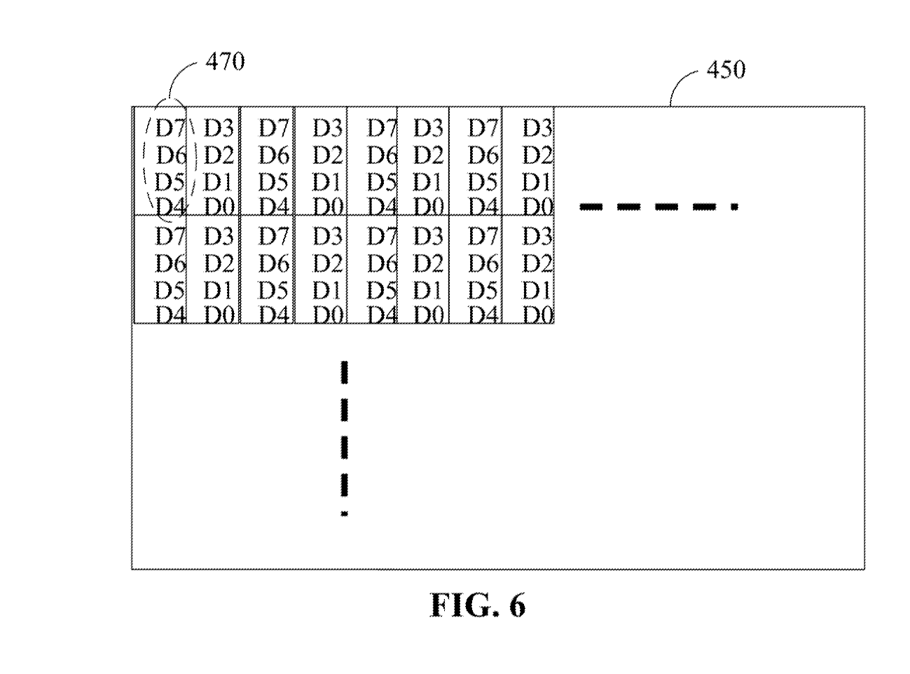

The method of inputting 16 source driving voltages V_{SD} by the source driving circuit 430 will be described as follows. Because 2⁴ equals 16, the source data signal S_{SD} inputted to the source driving circuit 430 by the controller 410 at least requires 4 bits for providing 16 voltage levels. That is, each pixel 470 (as shown in FIG. 6) requires a 4-bit source data signal S_{SD}. Please refer to FIGS. 4, 5, and 6. FIG. 5 illustrates a timing chart showing the source data signal S_{SD} which the controller 410 inputs to the source driving circuit 430. FIG. 6 illustrates the source data signal S_{SD} corresponding to the pixels of the electrophoretic display panel 450. In the present embodiment, 8 bits are inputted to the source driving circuit 430 by the controller 410 per time. The 8 bits are denoted as D7-D0. The D7-D0 are provided in a clock period as shown in FIG. 5. Since each pixel 470 requires 4 bits (D7-D4 or D3-D0), the gray level data of two pixels 470 are provided by the controller 470 per time. In the timing chart of FIG. 5, the written time T_{WRITE} includes the required time for providing the gray level data of all pixels 470 in one complete image by the controller 410. The driving voltages corresponding to each of the pixels 470 are respectively driven in different periods. That is, the gray level data of the pixels 470 are sequentially provided (i.e. not at the same time) by the controller 410. After the source data signal S_{SD} (i.e. the gray level data of each pixel 470) are provided to the source driving circuit 430 by the controller 410, the source driving circuit 430 determines the source driving voltage V_{SD} to be inputted to the TFTs (not shown) on the first glass substrate 452 according to the gray level data of each pixel 470. Please refer to TABLE 1, which shows the gray level data versus the various source driving voltages V_{SD} being inputted to the TFTs (not shown) on the first glass substrate 452 according to one embodiment of the present invention.

TABLE 1

| | |
|---|---|
| gray level data (D7-D4 or D3-D0) | V_{SD} |

| | | | | | |
|---|---|---|---|---|---|
| 0 | 0 | 0 | 0 | 0 | V |
| 0 | 0 | 0 | 1 | 3 | V |
| 0 | 0 | 1 | 0 | 5 | V |
| 0 | 0 | 1 | 1 | 7 | V |
| 0 | 1 | 0 | 0 | 9 | V |
| 0 | 1 | 0 | 1 | 11 | V |
| 0 | 1 | 0 | 1 | 13 | V |
| 0 | 1 | 1 | 1 | 15 | V |
| 1 | 0 | 0 | 0 | −15 | V |
| 1 | 0 | 0 | 1 | −13 | V |
| 1 | 0 | 1 | 0 | −11 | V |
| 1 | 0 | 1 | 1 | −9 | V |
| 1 | 1 | 0 | 0 | −7 | V |
| 1 | 1 | 0 | 1 | −5 | V |
| 1 | 1 | 1 | 0 | −3 | V |
| 1 | 1 | 1 | 1 | 0 | V |

As shown in TABLE 1, a maximum value of the source driving voltages V_{SD} is +15V, a minimum value of the source driving voltages V_{SD} is −15V, and intermediate values of the source driving voltages V_{SD} comprise +/−13V, +/−11V, +/−9V, +/−7V, +/−5V, +/−3V, +/−1V, and 0V. In the present embodiment, the intermediate values comprise the driving voltages having opposite polarities and the same absolute values.

For instance, when the gray level data D7-D4 (or D3-D0) are denoted as “0000”, the source driving voltages V_{SD} of the source driving circuit 430 is 0V. When the gray level data D7-D4 (or D3-D0) are denoted as “0001”, the source driving voltages V_{SD} of the source driving circuit 430 is 3V. The present embodiment may provide 15 different source driving voltages V_{SD}, which include +/−15V, +/−13V, +/−11V, +/−9V, +/−7V, +/−5V, +/−3V, and 0V. When the gray level data D7-D4 (or D3-D0) are denoted as “0000” or “1111”, the source driving voltages V_{SD} of the source driving circuit 430 is 0V.

Please refer to TABLE 1 and TABLE2. TABLE 2 shows the required gray level data for displaying 32 gray levels at a frame rate of 50 Hz. The source driving voltage V_{SD} of the source driving circuit 430 in a frame time lasts for 20 ms at the frame rate of 50 Hz. That is, one frame time is 20 ms. If the charged particles 460 are driven by a fixed voltage of +15V (or −15V) and the response time from the black level to the white level or from the white level to the black level is assumed to be 320 ms, so updating a complete image (frames 1-16 as shown in TABLE 2) requires 16 multiples of a frame time (320 ms/20 ms=16).

TABLE 2

| | gray | gray | | gray | gray |
|---|---|---|---|---|---|
| frame | level 0 | level 1 | . . . | level 30 | level 31 |
| 1 | 0000 | 0001 | . . . | 0110 | 0111 |
| 2 | 0000 | 0001 | . . . | 0110 | 0111 |
| 3 | 0000 | 0001 | . . . | 0110 | 0111 |
| 4 | 0000 | 0000 | . . . | 0111 | 0111 |
| 5 | 0000 | 0000 | . . . | 0111 | 0111 |
| 6 | 0000 | 0000 | . . . | 0111 | 0111 |
| 7 | 0000 | 0000 | . . . | 0111 | 0111 |
| 8 | 0000 | 0000 | . . . | 0111 | 0111 |
| 9 | 0000 | 0000 | . . . | 0111 | 0111 |
| 10 | 0000 | 0000 | . . . | 0111 | 0111 |
| 11 | 0000 | 0000 | . . . | 0111 | 0111 |
| 12 | 0000 | 0000 | . . . | 0111 | 0111 |
| 13 | 0000 | 0000 | . . . | 0111 | 0111 |
| 14 | 0000 | 0000 | . . . | 0111 | 0111 |
| 15 | 0000 | 0000 | . . . | 0111 | 0111 |
| 16 | 0000 | 0000 | . . . | 0111 | 0111 |

For example, when the pixel 470 is required to display the gray level 1, the controller 410 has to input the gray level data denoted as “0001” to the source driving circuit 430 from the frame 1 to the frame 3. It can be seen from TABLE 1 that the source driving circuit 430 outputs 3V to the electrophoretic display panel 450. Then, the controller 410 has to input the gray level data denoted as “0000” to the source driving circuit 430 from the frame 4 to the frame 16. It can be seen from TABLE 1 that the source driving circuit 430 outputs 0V to the electrophoretic display panel 450. In another example, when the pixel 470 is required to display the gray level 30, the controller 410 has to input the gray level data denoted as “0110” to the source driving circuit 430 from the frame 1 to the frame 3. It can be seen from TABLE 1 that the source driving circuit 430 outputs 13V to the electrophoretic display panel 450. Then, the controller 410 has to input the gray level data denoted as “0111” to the source driving circuit 430 from the frame 4 to the frame 16. It can be seen from TABLE 1 that the source driving circuit 430 outputs 15V to the electrophoretic display panel 450.

It is noted that the required gray level data from the gray level 0 to the gray level 31 in the frames 1-16 are based on characteristics of the electrophoretic display panel 450. That is, the electrophoretic layer 456 has to be measured to obtain a relationship between the driving time and the gray level, and therefore the required gray level data from the gray level 0 to the gray level 31 in the frames 1-16 are determined according to the relationship between the driving time and the gray level.

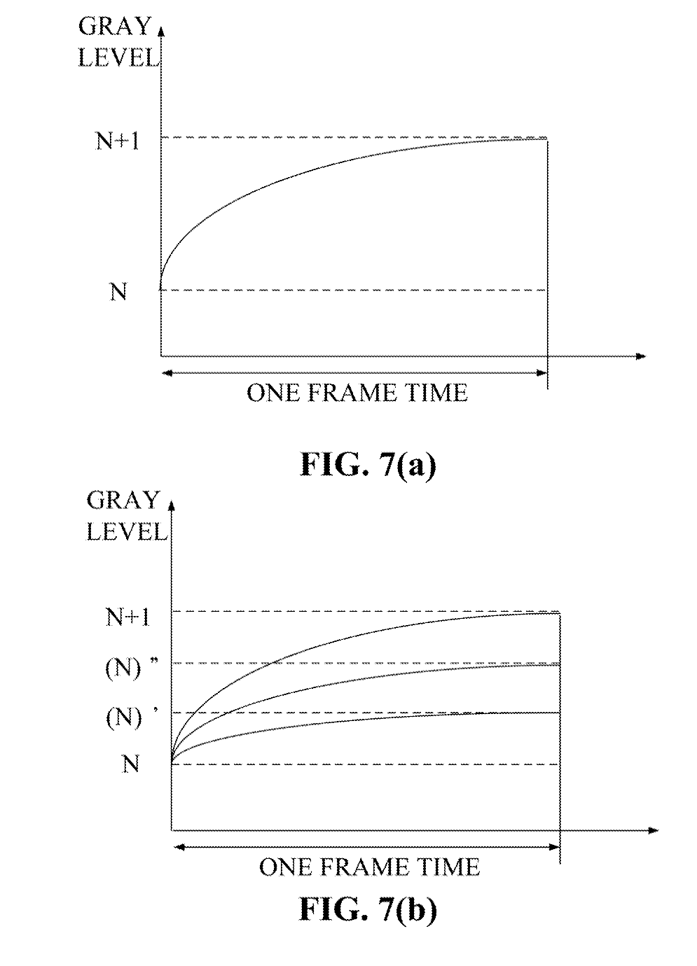

Please refer to FIG. 7(a) and FIG. 7(b). FIG. 7(a) illustrates a graph showing a relationship between the gray level and the driving time in the conventional electrophoretic display device. FIG. 7(b) illustrates a relationship between the gray level and the driving time in the electrophoretic display device 400 of the present invention. As mentioned above, the source driving circuit can only output +/−15V to drive the charged particles to change the locations in the conventional electrophoretic display device. When the frame rate is 50 Hz and the response time from black level to white level or from white level to black level is assumed to be 320 ms in a fixed voltage of +15 voltage (or −15 voltage), 16 frames can be driven. If one gray level can be increased in a frame time, the gray level (N) can only be increased to the gray level (N+1) as shown in FIG. 7(a). However, the present invention provides a plurality of driving voltages to be selected, and therefore more gray levels, such as the gray level (N)′ and the gray level (N+1)″ as shown in FIG. 7(b), can be increased between the gray level (N) and the gray level (N+1) in a frame time. As a result, an object of displaying more gray levels such as 32 gray levels or 64 gray levels can be achieved.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An electrophoretic display device, comprising:
a plurality of pixels;
a first electrode layer corresponding to the pixels;
a second electrode layer corresponding to the first electrode layer and coupled to a common voltage;
a driving voltage generating unit providing a set of driving voltages, the set of driving voltages comprising a maximum value, a minimum value, and at least one intermediate value; and
an electrophoretic layer disposed between the first electrode layer and the second electrode layer, the electrophoretic layer having a plurality of charged particles, wherein each of the pixels is corresponding to a proportion of the charged particles, and the proportion of the charged particles is driven by an electric field formed by one of the set of the driving voltages and the common voltage.

2. The electrophoretic display device of claim 1, wherein the set of the driving voltages comprises the maximum value, the minimum value, and a plurality of intermediate values, and the plurality of intermediate values comprise the driving voltages having opposite polarities and the same absolute values.

3. The electrophoretic display device of claim 1, wherein the driving voltage generating unit comprises a source driving circuit.

4. The electrophoretic display device of claim 3, further comprising a controller for controlling the source driving circuit.

5. The electrophoretic display device of claim 1, further comprising a power supply for providing the common voltage.

6. The electrophoretic display device of claim 5, further comprising a controller for controlling the power supply.

7. The electrophoretic display device of claim 1, wherein the first electrode layer is an indium tin oxide layer and manufactured onto a first glass substrate.

8. A method for driving an electrophoretic display device, the electrophoretic display device comprising a plurality of pixels, a first electrode layer, a second electrode layer corresponding to the first electrode layer, a driving voltage generating unit coupled to the first electrode layer, and an electrophoretic layer disposed between the first electrode layer and the second electrode layer, the electrophoretic layer comprising a plurality of charged particles, the first electrode layer corresponding to the pixels, and each of the pixels corresponding to a proportion of the charged particles, the method comprising the steps of:
the driving voltage generating unit providing at least one driving voltage corresponding to each of the pixels, wherein the at least one driving voltage is one selected from a group consisting of a maximum value, a minimum value, and at least one intermediate value; and
providing a common voltage for the second electrode layer, and the proportion of the charged particles being driven by an electric field formed by the at least one driving voltage corresponding to each of the pixels and the common voltage.

9. The method of claim 8, wherein the set of the driving voltages comprises the maximum value, the minimum value, and a plurality of intermediate values, and the plurality of intermediate values comprise the driving voltages having opposite polarities and the same absolute values.

10. The method of claim 8, wherein the driving voltages corresponding to each of the pixels are respectively driven in different periods.
